(19) United States
(12) Patent Application Publication
(10) Pub. No.: US 2005/0085110 A1
(43) Pub. Date: Apr. 21, 2005

(54) Combination of electrical connectors

(75) Inventors: Chia-Yen Chai, Taipei Hsien (TW); Fu-Chen Chou, Taipei Hsien (TW); Pi-Ching Chen, Taipei Hsien (TW)

Correspondence Address: BRUCE H. TROXELL;SUITE 1404, 5205 LEESBURG PIKE, FALLS CHURCH, VA, 22041, US

(73) Assignee: Comax Technology Inc.

(21) Appl. No.: 10/756,282

(22) Filed: Jan. 14, 2004

(30) Foreign Application Priority Data
Oct. 15, 2003 (TW) 092218344

(51) Int. Cl. H01R 12/00

(52) U.S. Cl. 439/81

(57) ABSTRACT

A combination of electrical connectors comprising a connecting part each is installed on front, back or the proper location, such as one sidewall of the connector to have the two connectors connected in parallel after combination; two inserting portions are installed horizontally on two sides of the connecting part to be inserted into the inserting slots of the sidewall of the connector; a partition is between the two inserting portions to have two connectors maintain certain distance.

### BACKGROUND OF THE INVENTION

I. Field of the Invention

This invention relates generally to a combination of electrical connectors and, more specifically, to a combination of electrical connectors that has a connecting part each is installed on front, back or the proper location of the connector to have the two connectors connected in parallel after combination, a partition on the connecting part is located between the connector to have two connectors maintain certain distance.

II. Description of the Prior Art

Heretofore, it is known that the connectors applied on computer main boards are usually single type and independent of each other; however, technology advances, many interfaces and connectors keep expanding, many manufacturers modify their molds that causes more expense spending.

Some researches such as a Taiwanese pattern no. 549640 applies a fixed frame to combine two connectors, the design solves most of the issues to combine connectors, however the design is very complex, the mold design is a huge task; while manufacturing, the products are not easy to meet the original design, out of shape is a big issue, the cost becomes very high to be economical.

### SUMMARY OF THE INVENTION

It is therefore a primary object of the invention to provide a combination of electrical connectors that offers a simple and economical method to have two connectors connected in parallel after combination.

In order to achieve the objective set forth, a combination of electrical connectors in accordance with the present invention comprises a connecting part each is installed on front, back or the proper location, such as one sidewall of the connector to have the two connectors connected in parallel after combination; two inserting portions are installed horizontally on two sides of the connecting part to be inserted into the inserting slots on the sidewall of the connector; a partition is between the two inserting portions to have two connectors maintain certain distance.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective of the present invention;

FIG. 2 is an assembly view of the present invention; and

FIG. 3 is a cross-sectional view of the present invention.

### DESCRIPTION OF THE PREFERRED EMBODIMENT

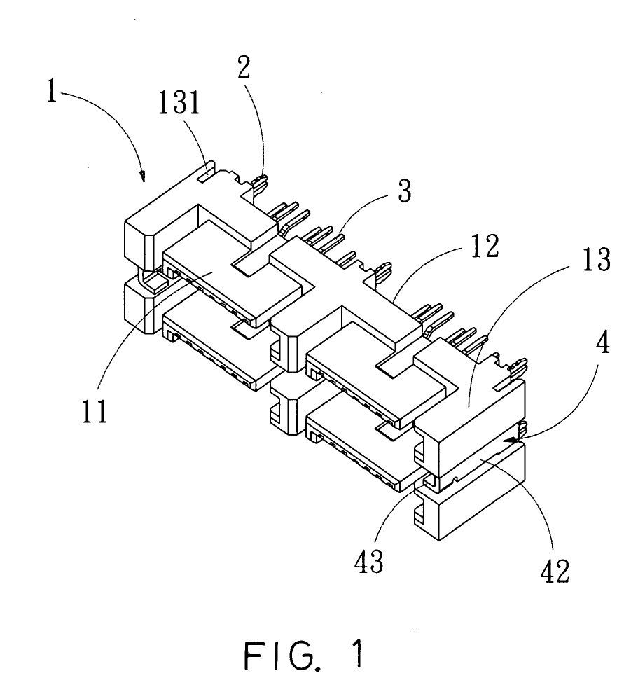

Referring to FIG. 1, the application of the present invention, a connecting part 4 each is installed on front, back or the proper location, such as one sidewall 13 of the connector 1 to have the two connectors 1 connected in parallel after combination.

The connector 1 consists of a transmission portion 11 and a fastening portion 12; the connector 1 also has a definite number of fastening units 2 and a plurality connecting pins 3.

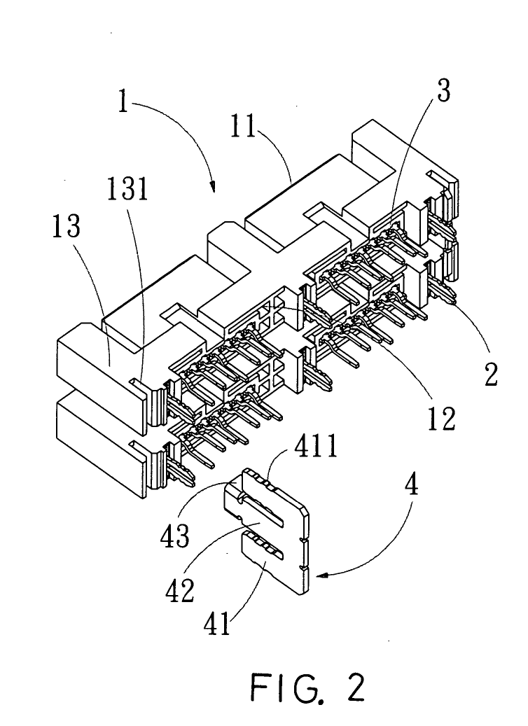

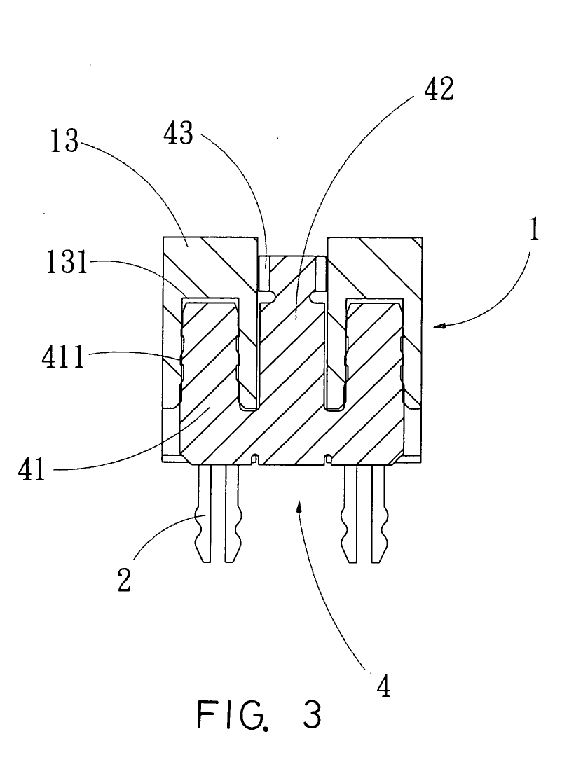

Referring to FIG. 2 and FIG. 3 shows an assembly view and a cross-sectional view of the present invention, two inserting portions 41 are installed horizontally on two sides of the connecting part 4 to be inserted into the inserting slots 131 of the sidewall 13 of the connector 1.

Two teeth portion 411 are on both side walls of the inserting portion 41 to fix the connector 1 and the connecting part 4 firmly together, a partition 42 is between two inserting portions 41 to have two connectors 1 maintain certain distance.

In order to maintain stable distance between two connectors 1, two parallel blockers 43 extend on sidewalls vertically of the partitions 42 to maintain the stable combination of two connectors 1.

Two connecting part are installed on front, back or proper location of two connectors to make the two connectors combine in parallel.

While a preferred embodiment of the invention has been shown and described in detail, it will be readily understood and appreciated that numerous omissions, changes and additions may be made without departing from the spirit and scope of the invention.

1. A combination of electrical connectors comprising:
at least one connecting part each is installed on front, back or the proper location, such as one sidewall of the connector to have the two connectors connected in parallel after combination;
two inserting portions are installed horizontally on two sides of said connecting part to be inserted into the inserting slots of the sidewall of the connector; and
a partition is between two said inserting portions to have two connectors maintain certain distance.

2. The combination of electrical connectors recited in claim 1, wherein two teeth portion are on both sidewalls of said inserting portion to fix the connector and said connecting part firmly together.

3. The combination of electrical connectors recited in claim 1, wherein two parallel blockers extend on sidewalls vertically of said partitions to maintain the stable combination of two connectors.
